(19) United States
(12) Patent Application Publication
(10) Pub. No.: US 2007/0046578 A1
(43) Pub. Date: Mar. 1, 2007

(54) PLASMA DISPLAY APPARATUS AND DRIVING METHOD THEREOF

(75) Inventors: Hai Young JUNG, Inchun-si (KR); Byung Nam AHN, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/466,635

(22) Filed: Aug. 23, 2006

(30) Foreign Application Priority Data
Aug. 23, 2005 (KR) 10-2005-0077414
Aug. 31, 2005 (KR) 10-2005-0080766

(51) Int. Cl. G09G 3/28

(52) U.S. Cl. 345/68

(57) ABSTRACT

The present invention relates to a plasma display apparatus and a driving method thereof. The present invention can cut off current flowing into the sustain drivers 40, 140, and 240 when the set-up signal R_up or set-down sigal R_dn is applied, even without any other switching elements by using a switching element (path-blocking switch, Sblock) with smaller capacity or by connecting the set-up switch SET_UP and the high switches 31a, 131a and 231a of the scan ICs 31, 131, and 231.

This Nonprovisional application claims priority under 35 U.S.C. §119(a) on Patent Application No. 10-2005-0077414 filed in Korea on Aug. 23, 2005 Patent Application No. 10-2005-0080766 filed in Korea on Aug. 31, 2005 the entire contents of which are hereby incorporated by reference.

### BACKGROUND OF THE INVENTION

1. Field of the Invention

The present invention relates to a plasma display apparatus and a driving method thereof, and more particularly to a plasma display apparatus and a driving method thereof that can stably apply set-up signals and set-down signals without a cut-off switch, which prevents set-up signals and set-down signals from flowing back.

2. Description of the Conventional Art

A plasma display apparatus includes a rear substrate formed with barrier ribs and a front substrate facing the rear substrate, and implements images by exciting phosphors by vacuum ultraviolet rays generated when inert gases injected into a plurality of discharge cells formed between the front substrate and rear substrate are discharged by high frequency voltages.

As shown in FIG. 1, on the front substrate A are sequentially formed a scan electrode 1 and a sustain electrode 2, a dielectric layer 3 deposited on the scan electrode and sustain electrode, and a protective film 4 applied on the dielectric layer.

When a driving signal for driving a plasma display panel is supplied to the scan electrode 1 and sustain electrode 2, wall charges are accumulated on the dielectric layer 3, and the protective film 4 prevents any possible damage to the dielectric layer 3 from sputtering and raises the emission efficiency of secondary electrons.

An address electrode 6 is formed on the rear substrate B, and a dielectric layer 8, on which wall charges are to be accumulated, is sequentially formed on the address electrode.

On the dielectric layer 8 are formed barrier ribs 7 of partitioning discharge spaces and phosphors 9 applied on the side surfaces of the barrier ribs and the bottom surfaces of the discharge spaces and excited by ultraviolet rays generated by a discharge to emit any one of red, green, or blue visible rays.

A plurality of address electrodes X are formed on the rear substrate, and a plurality of scan electrodes Y and sustain electrodes Z intersecting the address electrodes X are formed on the front substrate.

One frame is divided into various sub-fields having the different number of times of light emission and time-dividely driven so as to display images on the plasma display apparatus configured as above. The respective subfields, as shown in FIG. 2, include a reset period R, an address period A, and a sustain period S.

Viewing the reset signal applied to the scan electrode Y during a reset period R, the set-up signal R_up rises to a constant voltage from a ground level GND and then rises further up to the set-up voltage Vsetup taking a ramp wave shape. The set-down signal R_dn falls up to a given voltage, and then falls further up to the set-down voltage Vsetdn taking a ramp wave shape.

A negative (−) bias voltage may be applied to the sustain electrode Z to activate the formation of wall charges inside the discharge cells during the whole or part of the reset period R.

A scan voltage Vsc is applied to the scan electrode Y during an address period A, and the scan electrode Y sustains a scan bias voltage Vby. At this time, the scan voltage Vsc is applied to the scan electrode Y with the lowest voltage level Vsetdn of the set-down reset signal R_dn, because the negative (−) set-down voltage Vsetdn is in the state of being applied to the scan electrode Y at the end of reset period R.

At this time, a data pulse dp from video data is applied to the address electrode X, and a scan pulse scp is applied to the scan electrode Y to be opposite to the data pulse dp; if the scan pulse is applied, then the voltage of the scan electrode Y is reduced up to the lowest scan voltage −Vy.

If the data pulse dp and scan pulse scp are applied as above, an address discharge is generated between the scan electrode Y and address electrode X; at this time, a negative (−) bias voltage may be applied to the sustain electrode Z so as to enhance the address discharge generated between the electrodes X and Y.

If the sustain period S starts, a sustain pulse sus is alternately applied to the scan electrode Y and sustain electrode Z. If the sustain pulse is applied, a discharge is generated between the scan electrode and sustain electrode and displays images.

Here, a difference between the high potential voltage and low potential voltage of the sustain pulse sus supplied to the scan electrode Y or sustain electrode Z during the sustain period S is referred to as sustain voltage Vs.

To drive the plasma display panel as above, there are provided a set-up driver 1 for applying a set-up signal R_up, a set-down driver 2 for applying a set-down signal R_dn, a scan driver for applying a scan voltage Vsc, an energy recovering unit ER for recovering a reactive current stored in the panel and reusing it, and a sustain driver 4 connected to the energy recovering unit and for applying a sustain pulse, as shown in FIG. 3.

In the reset period R, if a set-up switch SET_UP connected to a positive (+) external power souce Vsetup is conducted, a ramp wave shape of set-up signal R_up is applied, and if a set-down switch SET_DN connected to a negative (−) external power source (−Vy=Vsetdn) is conducted, a set-down signal R_dn is applied.

When an address period A starts, if a scan switch SCAN provided in the scan driver 3 is conducted, a scan voltage Vsc is applied to the panel and thereby the scan electrode Y has the scan bias voltage Vby.

If the scan switch SW is conducted to apply the scan pulse scp to the scan electrode Y, the lowest scan voltage −Vy is applied to the scan electrode.

The sustain pulse sus is applied by adjusting ON/OFF timing of the switches ER_UP or ER_DN provided in the energy recovering unit ER and switches SUS_UP or SUS_DN provided in the sustain driver 4.

At this time, the high potential voltage of the sustain pulse sus has the magnitude of the sustain voltage Vs and its low potential voltage has the magnitude of base voltage GND since the switches in the sustain driver 4 are respectively connected to a voltage source of applying the sustain voltage Vs and base voltage GND.

In the circuit as above, a current may flow back when the set_up signal R_up or set_down signal R_dn and scan signal scp are applied, and thereby signal distortion may be created.

That is, if the set-up switch SET_UP is conducted during the reset period R, a current path is created from the set-up switch through a scan IC to the panel and the set-up signal R_up is applied; at this time, a current to have passed through the set-up switch may flow to the sustain driver 4.

In this case, the normal set-up signal R_up can not be applied to the scan electrode Y, and thus a separate switch PASS_BOTTOM (hereinafter, referred to as a “first cutoff switch”) is provided to block the reverse current.

If the first cutoff switch PASS_BOTTOM is provided between the set-up driver 1 and sustain driver 4, a current to have passed through the set-up switch does not flow back even when the set-up switch SET_UP is conducted and thus the distortion of the set-up signal is reduced.

In addition, even when the set-down signal R_dn is applied, the voltage of the scan electrode Y should be decreased up to the set-down voltage=−Vy if the set-down switch SET_DN is conducted.

However, since the set-down switch SET_DN is connected to the sustain driver 4, a current path Idn from the scan electrode Y to the second sustain switch SUS_DN of the sustain driver 4 is created and thereby the set-down signal R_dn is not normally applied.

Even when the scan pulse scp is applied, a current path Idn from the scan electrode Y to the second sustain switch SUS_DN is created although the scan pulse switch SW is conducted, and thereby the scan pulse can not reach the lowest scan voltage −Vy.

A second cutoff switch PASS_TOP is provided between the set-up driver 1 and scan driver 3 to protect this, and blocks the current path Idn from the scan electrode Y to the second sustain switch SUS_DN when the set-down signal R_dn or scan pulse scp is applied, and thus signal distortion can be reduced efficiently.

Whereas it is possible to supply signals stably when the set-up signal R_up and set-down signal R_dn, and scan pulse scp are applied in a case where the first and second cutoff switches PASS_BOTTOM and PASS_TOP are provided as above, both of a resonant current and discharge current flow to the first and second switches PASS_BOTTOM and PASS_TOP when the sustain pulse sus is applied, and thus a large capacity switch is connected in parallel and used.

In the case where the large capacity switch is connected in parallel and used as above, signal distortion can be created, and in addition the parasitic resistant component existed on the circuit and voltage dropping component by the switching elements are increased and thus the recovery efficiency of the energy recovering unit ER is decreased, and this may cause the increase of consumption power in the plasma display panel.

Moreover, if the number of switches used is increased, the size of the circuit is enlarged, which increases the size of board in which the circuit is to be mounted, and thereby cost required to configure the circuit may also be increased.

### SUMMARY OF THE INVENTION

The present invention is designed to solve the aforementioned problems of the prior art, and it is an object of the present invention to apply the stable set-up signal and set-down signal using a small capacity switching element or without a separate switching element as driving waveforms for driving a plasma display apparatus are formed using any positive voltage and negative voltage.

For the purpose of accomplishing this object, a plasma display apparatus according to the present invention includes a set-up switch for applying a set-up signal to a scan IC, and a set-down switch for applying a set-down signal to a scan IC, wherein the set-up switch is connected to the scan IC, and the set-down switch is connected to an inductor of an energy recovering unit for recovering a reactive current of a panel.

At this time, a capacitor is connected in parallel to the set-up switch, and the scan IC includes a high switch for forming a path of the set-up signal applied to the panel, and a low switch for forming a path of the set-down signal applied to the panel.

The energy recovering unit includes one or more switch and an inductor for recovering a current of the panel during a sustain period, and a source capacitor for storing the reactive current recovered from the panel, and a sustain driver for applying a sustain pulse is connected to the energy recovering unit, wherein it is desirable that the sustain driver includes at least two switches.

A driving method of a plasma display apparatus configured as above includes supplying to a first electrode a voltage rising from a low potential sustain voltage to a first set-up voltage during the reset period, supplying to the first electrode a voltage rising from the first set-up voltage to a second set-up voltage in a ramp waveform, reducing a voltage of the first electrode from the second set-up voltage to the first set-up voltage, and supplying to the first electrode a voltage falling from the second set-up voltage to a set-down voltage in a ramp waveform, wherein the first set-up voltage is formed to be equal to a high potential sustain voltage.

Here, a middle voltage (hereinafter referred to as a sustain central voltage) between the high potential sustain voltage and the low potential sustain voltage may be set to a ground level GND, a predetermined positive (+) voltage level, or a negative (−) voltage level variously.

That is, in case that the plasma display apparatus is driven in the half sustain type, the set-up switch provided for applying the set-up voltage and the switch provided for applying the high potential sustain voltage are connected to the same voltage source, and the set-down switch provided for applying the set-down voltage and the switch provided for applying the low potential sustain voltage are connected to the same voltage source, and thereby the plasma display apparatus can be constructed without a separate cutoff switch.

### BRIEF DESCRIPTION OF THE DRAWING

FIG. 1 is a view illustrating a panel construction of a general plasma display apparatus;

FIG. 2 is a view illustrating a driving waveform for driving a conventional plasma display apparatus;

FIG. 3 is a view illustrating a conventional plasma display apparatus;

FIG. 4 is a view illustrating a driving waveform by the half sustain driving type according to an embodiment of the present invention;

FIG. 5 is a view illustrating a plasma display apparatus according to a first embodiment of the present invention;

FIG. 6A is a view illustrating a set-up signal applied to a plasma display apparatus according to a first embodiment of the present invention;

FIG. 6B is a view illustrating a set-up signal applied to a plasma display apparatus according to a second embodiment of the present invention;

FIGS. 7A through 7E are views illustrating a current flow of the plasma display apparatus according to the first embodiment of the present invention;

FIG. 8 is a view illustrating a plasma display apparatus according to a second embodiment of the present invention;

FIGS. 9A through 9E are views illustrating a current flow of the plasma display apparatus according to the second embodiment of the present invention;

FIG. 10 is a view illustrating a plasma display apparatus according to a third embodiment of the present invention;

FIGS. 11A through 11E are views illustrating a current flow of the plasma display apparatus according to the third embodiment of the present invention; and

FIGS. 12A through 12C are views illustrating a driving waveform of a plasma display apparatus according to an embodiment of the present invention.

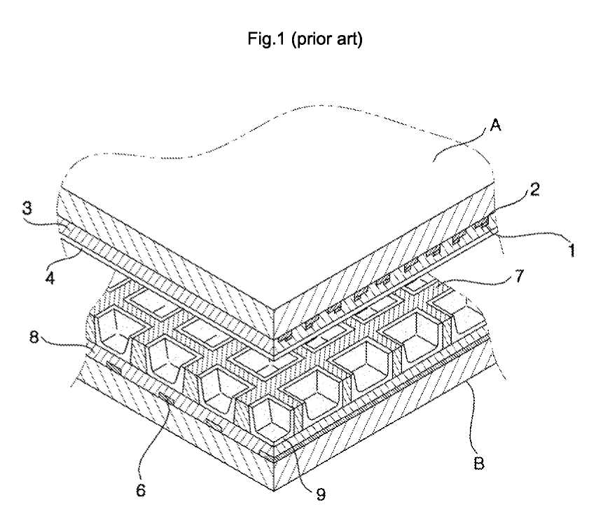

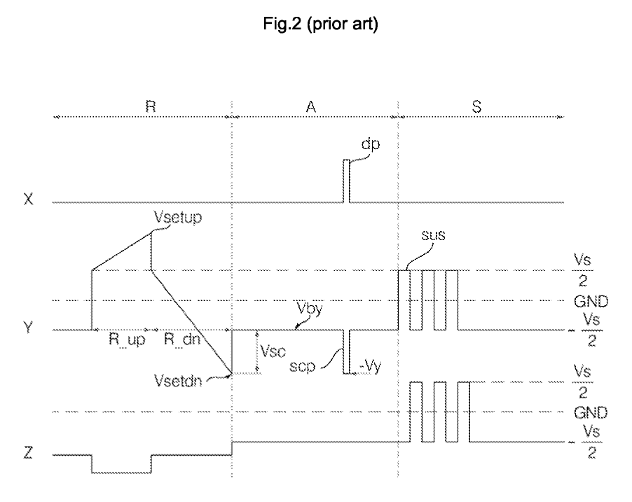

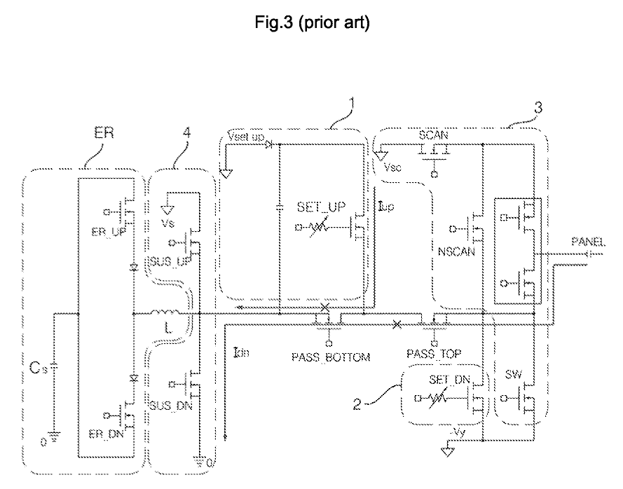

### DETAILED DESCRIPTION OF THE PREFERRED EMBODIMENT

Hereinafter, embodiments of a plasma display apparatus and a driving waveform for driving a plasma display panel according to the present invention will be described below with reference to the appending drawings.

The plasma display panel is time-dividedly driven with one frame divided into a number of sub-fields to display images. Each sub-field consists of a reset period for initializing the charge state inside a discharge cell to the same condition, an address period for addressing image data on a selected scan line, and a sustain period for implementing a gray level by creating a sustain discharge at the cell (on cell) selected in accord with the image data.

Sustain pulses are alternately applied to a scan electrode Y and a sustain electrode Z provided on the front substrate of the panel during the sustain period, and thereby a sustain discharge occurred between the both electrodes and a gray level is represented.

Hereafter, embodiments of the present invention will be described with reference to the accompanying drawings.

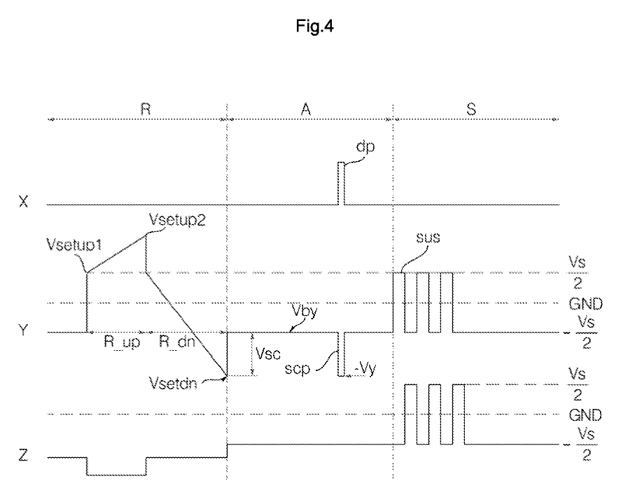

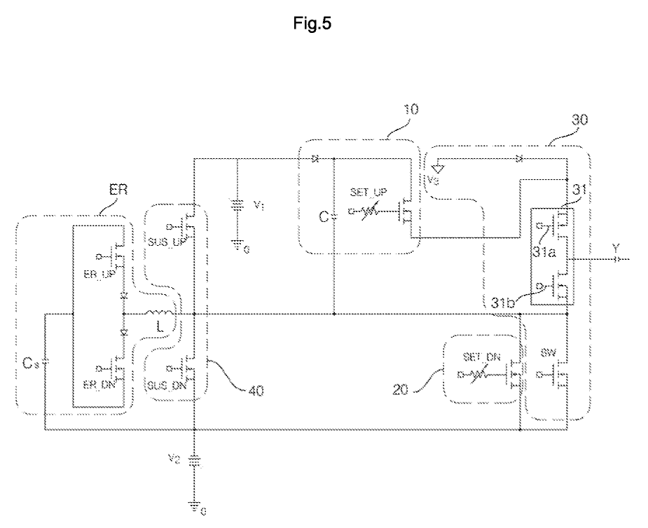

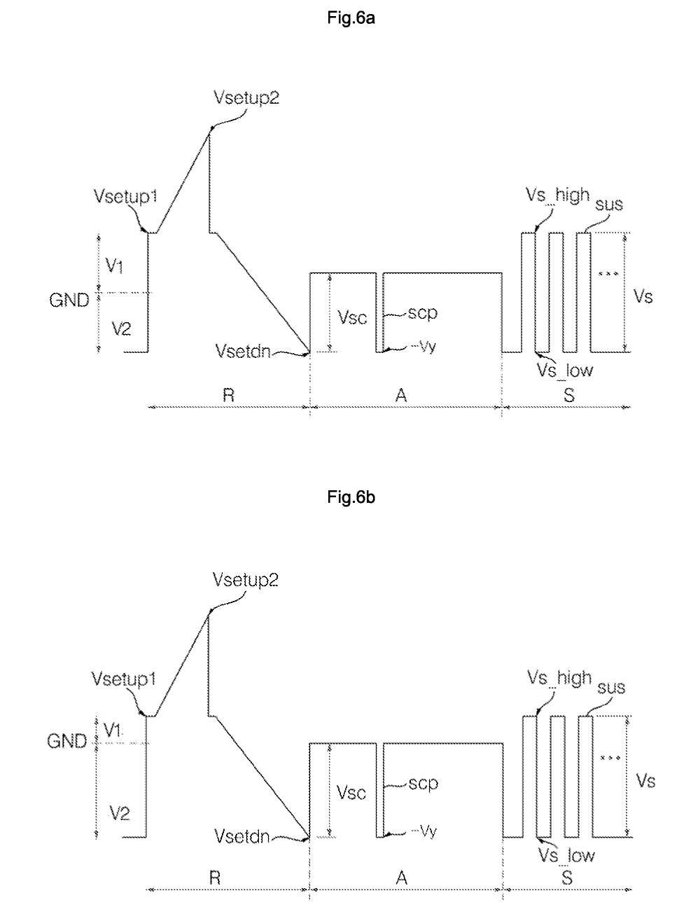

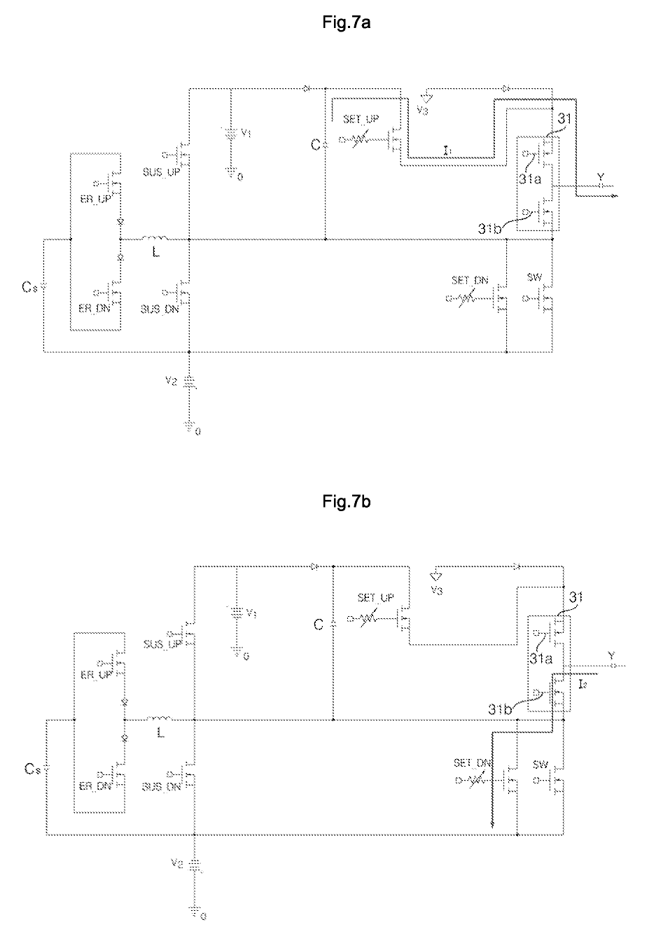

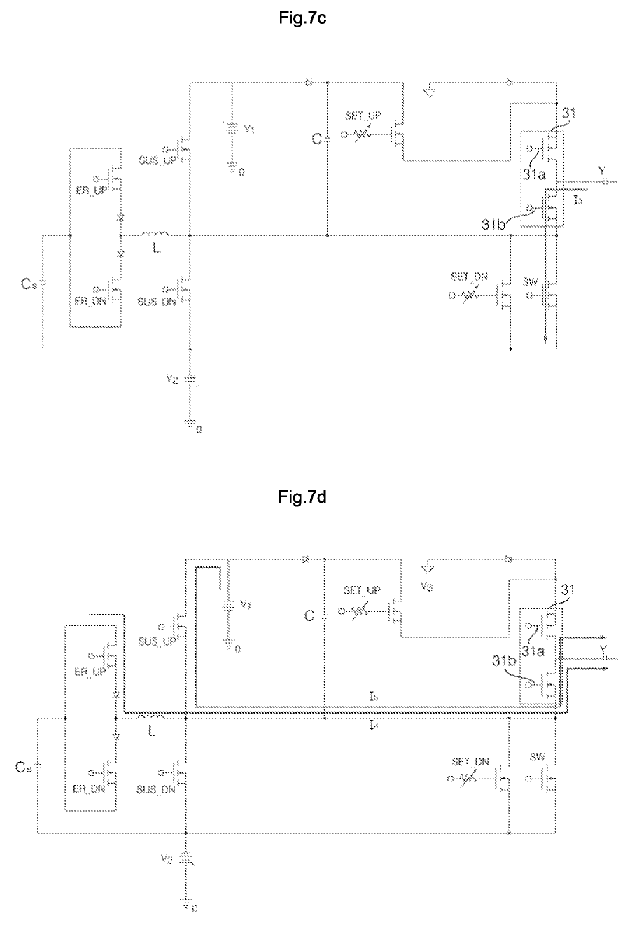

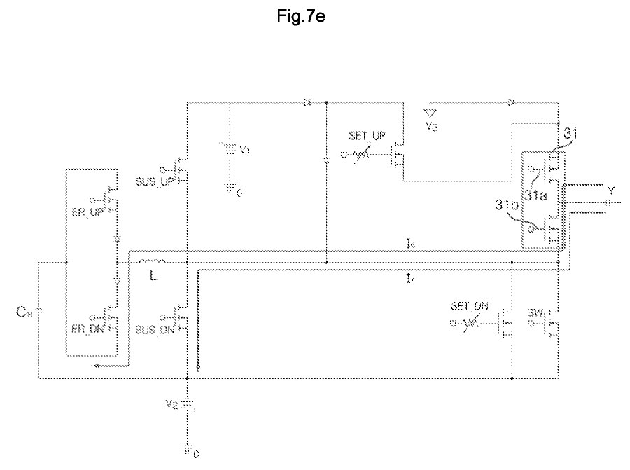

FIG. 4 is a view illustrating a driving waveform by the half sustain driving type according to an embodiment of the present invention, FIG. 5 is a view illustrating a plasma display apparatus according to a first embodiment of the present invention, FIGS. 6A and 6B are views illustrating a set-up signal applied to a plasma display apparatus according to an embodiment of the present invention, and FIGS. 7A through 7E are views illustrating a current flow of the plasma display apparatus according to the first embodiment of the present invention.

First, a set-up reset signal R_up and a set-down reset signal R_dn are sequentially supplied to the scan electrode Y and eliminate wall charges within a discharge cell to initialize, in the driving waveform for driving the plasma display apparatus as shown in FIG. 4.

The set-up signal R_up is a signal rising in the ramp waveform from a positive (+) first set-up voltage Vsetup1 to a second set-up voltage Vsetup2. A reset discharge occurs between a scan electrode Y and an address electrode X inside the whole discharge cells by the set-up signal R_up and wall charges are created inside the discharge cells.

The set-down signal R_dn is decreased from the second set-up signal Vsetup2 to the first set-up signal Vsetup1, and subsequently further reduced to a negative set-down voltage Vsetdn in the ramp waveform.

Once the discharge cell is initialized, a positive (+) data pulse dp is applied to the address electrode X in accord with image data, and a negative (−) scan pulse scp opposite to the data pulse is supplied to the scan electrode Y, and thereby an address discharge is created. The scan pulse scp is a scan voltage Vsc falling from a scan bias voltage Vby to a negative (−) lowest scan voltage −Vy.

Here, the set-down voltage Vsetdn and lowest scan voltage −Vy may be formed similarly or differently; the detailed description will be described assuming that the set-down voltage is equal to the lowest scan voltage, but the set-down voltage and lowest scan voltage may be formed differently in the range from several volts to several tens of volts.

Then, if a sustain pulse sus is alternately supplied to the scan electrode Y and sustain electrode Z, a sustain discharge is created at the cell where the address discharge occurred, thus displaying images.

The difference between high potential voltage and low potential voltage of the sustain pulse sus supplied to the scan electrode Y or sustain electrode Z during the sustain period S is referred to as a sustain voltage Vs and, in the case that absolute values of high potential sustain voltage and low potential sustain voltage of the sustain pulse are the same and the absolute values are the half of the sustain voltage, this is called the half sustain driving type.

That is, in case of the half sustain driving type, the low potential voltage of the sustain pulse sus is not the base voltage, i.e. the ground level of voltage, but a negative (−) voltage, and its magnitude is typically the half (Vs/2) of the sustain voltage.

In case of the half sustain driving type, the set-up signal is applied, which rises up to the half (Vs/2) of the sustain voltage Vs from the ground level GND and then further rises to the second set-up voltage Vsetup2 taking a ramp waveform during the reset period R, as shown in FIG. 4. Then, the set-down signal R_dn is applied, which falls up to the half (Vs/2) of the sustain voltage and then further falls to the set-down voltage Vsetdn taking a ramp waveform.

The scan voltage Vsc is applied to the scan electrode Y during the address period A, where the scan voltage Vsc is applied to the scan electrode Y in the state of the lowest level (−Vy) of the set-down reset signal R_dn and this forms a scan bias voltage Vby.

At this time, if a data pulse dp from video data is applied to the address electrode X, a scan pulse scp is applied to the scan electrode Y to be opposite to the data pulse dp; if the scan pulse scp is applied, then the voltage of the scan electrode Y is reduced up to the lowest scan voltage −Vy.

If the sustain period S starts, a sustain pulse sus is alternately applied to the scan electrode Y and sustain electrode Z. The sustain pulse sus is formed by rising up to the half (Vs/2) of the sustain voltage in the positive (+) direction with respect to the ground level GND, and falling up to the half (Vs/2) of the sustain voltage in the negative (−) direction.

In the half sustain driving type as described above, a reset signal R, an address signal A, and a sustain signal S are applied with respect to −Vs/2, and this allows for driving the plasma display apparatus stably and raise its driving margin.

The plasma display apparatus of the present invention driven by the aforementioned driving waveform will be described based on a circuit construction for applying a set-up signal R_up, a set-down signal R_dn, a scan pulse scp, and a sustain pulse sus to the scan electrode Y.

A first embodiment of the plasma display apparatus includes a set-up driver 10 for applying a set-up signal R_up, a set-down driver 20 for applying a set-down signal R_dn, a scan driver for applying a scan voltage Vsc, an energy recovering unit ER for recovering a current and reusing it, and a sustain driver 40 connected to the energy recovering unit and for applying a sustain pulse, as shown in FIG. 5.

A driving waveform applied to the scan electrode Y and a circuit construction for applying the driving waveform will be described as an example in this embodiment, and driving waveforms applied to the address electrode X and sustain electrode Z and circuit constructions for applying the driving waveforms may employ well-known driving waveforms and driving circuits.

The set-up driving part 10 includes a set-up switch SET_UP for applying the second set-up voltage Vsetup2 to the scan electrode Y as conducted and a capacitor C connected in parallel with the set-up switch SET_UP.

One end of the set-up switch SET_UP is connected to a positive (+) first voltage source V1 to apply the second set-up voltage Vsetup2 and the other end is connected to a scan IC 31 of the scan driver 30 to be described later. Since the set-up switch SET_UP is connected to the first voltage source V1, the second set-up voltage Vsetup2 has the magnitude of the first voltage source V1.

One end of the capacitor C is connected to the first voltage source V1, and the other end is connected to the sustain driver 40 and set-down switch SET_DN to be described later, and thereby the voltage as much as the difference between the first voltage source Vs1 and the second voltage source V2 to be described later is stored in the set-up switch SET_UP during the sustain period S.

The scan IC 31 includes a high switch 31a and a low switch 31b; in the first embodiment of the present invention, the high switch 31a forms a path of the set-up signal R_up applied to the scan electrode Y and the low switch 31b forms a path of the set-down signal R_dn.

The set-down driving part 20 includes a set-down switch SET_DN for applying the set-down voltage Vsetdn to the scan electrode Y, as conducted; one end of the set-down switch SET_DN is connected to the negative second voltage source V2 to apply the set-down voltage Vsetdn and the other end is connected to the scan IC 31.

Since the set-down switch SET_DN is connected to the second voltage source V2, the set-down voltage Vsetdn is formed equally to the second voltage source V2.

The scan driving part 30 includes the scan IC 31 connected to a positive (+) third voltage source V3 and applying the scan voltage Vsc to the scan electrode Y as conducted, and a scan pulse switch SW provided between the scan IC 31 and the negative (−) second voltage source V2 and applying the scan pulse scp to the scan electrode Y.

At this time, a reverse current prevention element, such as a diode, may be added between the scan IC 31 and the third voltage source V3. Since one end of the scan pulse switch SW is connected to the scan IC 31 and the other end is connected to the second voltage souce V2, the lowest scan voltage −Vy, which is formed with the scan pulse switch conducted, is formed equally to the magnitude of the second voltage source V2.

The sustain driver 40 includes a first switch SUS_UP for applying a high potential sustain voltage Vs_high as conducted, and a second switch SUS_DN for applying a low potential sustain voltage Vs_low as conducted.

One end of the first switch SUS_UP is connected to the first voltage source V1 and the other end is connected to an inductor L of the energy recovering unit ER; one end of the second switch SUS_DN is connected to the second voltage source V2 and the other end is connected to the inductor L of the energy recovering unit ER.

Since the first switch SUS_UP is configured to be connected to the first voltage source Vs1 and set-up switch SET_UP in the first embodiment of the present invention, the first voltage source V1 is applied to the scan electrode Y as the first switch SUS_UP is conducted. Therefore, the high potential sustain voltage Vs_high formed as the first switch SUS_UP is conducted is formed equally to the first voltage source V1.

Since the second switch SUS_DN is configured to be connected to the second voltage source V2 and set-down switch SET_DN, the second voltage source V2 is applied to the scan electrode Y as the second switch SUS_DN is conducted and thus the low potential sustain voltage Vs_low formed as the second switch SUS_DN is conducted is formed to have the same magnitude as that of the second voltage source V2.

The energy recovering unit ER includes a source capacitor Cs, a charging switch ER_UP for applying a current stored in the source capacitor Cs to the scan electrode Y, a recovering switch ER_DN for recovering a current from the scan electrode Y and charging the source capacitor Cs, and an inductor L for forming a resonant circuit.

One end of the source capacitor Cs is connected to the charging switch ER_UP and the other end is connected to the recovering switch ER_DN and the second voltage source −Vs2. Therefore, the voltage recovered and stored in the source capacitor Cs is formed to be the half of the voltage difference between the first voltage source Vs1 and the second voltage source −Vs2.

Here, the first and second set-up voltages Vsetup1, Vsetup2, set-down voltage Vsetdn, and the first voltage source Vs1 and second voltage source −Vs2 may be set up to have any values; it is desirable that the voltage difference between the first voltage source V1 and the second voltage source V2 should be set up constantly and as the sustain voltage Vs.

If the voltage difference between the first voltage source V1 and the second voltage source V2 equals the sustain voltage Vs and the absolute value of the first voltage source V1 is equal to that of the second voltage source V2, the driving waveform applied to the scan electrode Y is as shown in FIG. 6A.

That is, the first set-up voltage Vsetup1 is formed equally to the first voltage source V1, and the second set-up voltage Vsetup2 is also formed equally to the first voltage source V1. The set-down voltage Vsetdn is formed with the second voltage source V2, and the lowest scan voltage −Vy is also formed with the second voltage source V2.

Accordingly, the set-up signal R_UP rises vertically from the base level GND to the first set-up voltage Vsetup1 having the magnitude of the half (Vs/2) of the sustain voltage, and then rises further from the first set-up voltage Vsetup1 to the second set-up voltage Vsetup2 as much as the half (Vs/2) of the sustain voltage in a ramp waveform.

The set-down signal R_dn falls vertically from the second set-up voltage Vsetup2 to the first set-up voltage Vsetup1, and then falls further from the first set-up voltage Vsetup1 as much as the half (Vs/2) of the sustain voltage in a ramp waveform.

The sustain pulse sus repeats rising/falling between the first voltage source V1 and the second voltage source V2; the high potential sustain voltage Vs_high and low potential sustain voltage Vs_low of the sustain pulse sus are formed by swing with respect to the ground level GND.

If the voltage difference between the first voltage source V1 and the second voltage source −V2 equals the sustain voltage Vs and the absolute value of the first voltage source V1 is not equal to that of the second voltage source V2, the driving waveform applied to the scan electrode Y is varied.

FIG. 6B is a view illustrating a driving waveform applied to the scan electrode Y in case that the absolute value of the first voltage source V1 is not equal to that of the second voltage source V2 and the absolute value of the second voltage source V2 is greater than that of the first voltage source V1.

At this time, the set-up signal R_UP rises vertically from a middle voltage level between the high potential sustain voltage Vs_high and low potential sustain voltage Vs_low of the sustain pulse sus to the first set-up voltage Vsetup1 having the magnitude of the first voltage source V1, and then rises further from the first set-up voltage Vsetup1 to the second set-up voltage Vsetup2 as much as the half (Vs/2) of the sustain voltage in a ramp waveform.

The set-down signal R_dn falls vertically from the second set-up voltage Vsetup2 to the first set-up voltage Vsetup1, and then falls further from the first set-up voltage Vsetup1 as much as the sustain voltage Vs in a ramp waveform.

The sustain pulse sus repeats rising/falling between the first voltage source V1 and the second voltage source V2; the high potential sustain voltage Vs_high and low potential sustain voltage Vs_low of the sustain pulse sus are formed by swing with respect to a negative voltage.

Appling the driving waveform to the scan electrode Y using the first embodiment of the plasma display apparatus configured as above will be described as follows with reference to FIGS. 7A through 7E.

If the reset period R starts, the first switch SUS_UP of the sustain driver 40 is conducted and the first set-up voltage Vsetup1 equal to the first voltage source V1 is applied to the scan electrode Y.

Then, if the set-up switch SET_UP is conducted, the voltage rises from the first set-up voltage Vsetup1 to the second set-up voltage Vsetup2; this can be risen up to the second set-up voltage Vsetup2 in a ramp waveform by adjusting a variable resistor connected to the set-up switch SET_UP.

At this time, the voltage difference between the first set-up voltage Vsetup1 and the second set-up voltage Vsetup2 is formed equally to the voltage supplied from the first voltage source V1 in this embodiment, where the voltage supplied from the first voltage source V1 is formed as much as the half of the voltage difference between the high potential sustain voltage Vs_high and low potential sustain voltage Vs_low.

If the set-up switch SET_UP is conducted, a current path 11 passing through the high switch 31a of the scan IC 31 is formed, and thus the second set-up voltage Vsetup2 is applied from the first voltage source Vs1 to the scan electrode Y as shown in FIG. 7A. At this time, the high switch 31a of the scan IC 31 is turned on, and the low switch 31b is turned off.

Since the set-up switch SET_UP is connected to the scan IC 31, there exists no current flowing from the set-up switch SET_UP into the other driver 20 to 40 and thereby the set-up signal can be applied stably.

In particular, since there is provided a reverse current prevention element between the scan IC 31 and the third voltage source V3, it is possible to prevent the set-up signal R_UP from flowing into the third voltage source V3.

If the set-up switch SET_UP is turned off, the voltage of the scan electrode Y is reduced to the first set-up voltage Vsetup1. Subsequently, if the set-down switch SET_DN is conducted, the voltage of the scan electrode Y is decreased to the set-down voltage Vsetdn; this may be decreased to the set-down voltage in a ramp waveform by adjusting a variable resistor connected to the set-down switch.

That is, if the set-down switch SET_DN is conducted, a current path 12 passing through the low switch 31b of the scan IC 31 and the set-down switch is formed, and thus the voltage applied to the scan electrode Y is reduced to the second voltage source V2 as shown in FIG. 7B.

At this time, since the set-down switch SET_DN is connected to the second voltage source V2, the set-down voltage Vsetdn is formed equally to the second voltage source V2.

Since one end of the set-down switch SET_DN and one end of the second switch SUS_DN are both connected to the second voltage source V2, a current is flowed from the scan electrode Y to the second switch SUS_DN when the set-down switch SET_DN is conducted, and thereby it can be eliminated that the voltage applied to the scan electrode Y can not be reduced to the set-down voltage Vsetdn.

That is, since the set-down switch SET_DN and the second switch SUS_DN are connected to the same voltage source, a current leakage can be prevented when the set-down signal R_dn is applied, and thus the set-down signal can be applied stably without a separate cutoff switch.

Additionally, since the set-up switch SET_UP and set-down switch SET_DN are all constructed with lamp switches, a ramp waveform of voltage is applied to the scan electrode Y when the set-up switch or set-down switch is conducted.

When the address period A is initiated, the high switch 31a of the scan IC 31 is conducted and the scan voltage Vsc is applied from the third voltage source V3 to the scan electrode Y, and thereby the scan electrode Y has the scan bias voltage Vby.

The lowest scan voltage −Vy is allowed to be applied to the scan electrode by conducting the scan pulse switch SW provided in the scan driver 30 so as to apply the scan pulse scp to the scan electrode Y. If the scan pulse switch SW is conducted, a current path 13 passing from the scan IC 31 through the scan pulse switch SW is formed, and thereby the voltage of the scan electrode is reduced to the lowest scan voltage −Vy, as shown in FIG. 7C.

At this time, since one end of the scan pulse switch SW is connected to the second voltage source V2, the lowest scan voltage −Vy is formed with the second voltage source V2.

Since the scan pulse switch SW is also connected to the second switch SUS_DN likewise to the set-down switch SET_DN, there exists no current leakage to the second switch SUS_DN when the scan pulse switch SW is conducted and thus the scan pulse scp can be applied stably even without a separate cutoff switch.

If the sustain period S is initiated, a sustain pulse sus is applied to the scan electrode Y. First of all, if the charging switch ER_UP of the energy recovering unit ER is conducted, the voltage charged across the source capacitor Cs is LC-resonated and applied to the scan electrode Y.

At this time, as shown in FIG. 7D, a voltage of two times the voltage stored in the source capacitor Cs should be applied to the scan electrode Y by the resonance of the current 14 flowing from the source capacitor Cs to the panel.

However, the voltage applied to the scan electrode Y by the resonant current can not be two times the voltage stored in the source capacitor Cs due to voltage drop by parasitic resistance components existed on the circuit or circuit elements.

Accordingly, if the first switch SUS_UP of the sustain driver 40 is conducted, a current path 15 from the first voltage source Vs1 to the scan electrode Y is formed and thereby the high potential sustain voltage Vs_high is applied to the scan electrode Y.

If the recovering switch ER_DN is conducted, a current path 16 from the scan electrode Y through the recovering switch ER_DN to the source capacitor Cs is formed and thereby the current is recovered, as shown in FIG. 7E. At this time, the voltage recovered to the source capacitor Cs is formed to be approximately in the middle of the high potential sustain voltage Vs_high and low potential sustain voltage Vs_low.

Even in case that the voltage is recovered to the source capacitor Cs as above, the voltage of the scan electrode Y can not be lowered up to the low potential sustain voltage Vs_low, and thus the voltage of the scan electrode Y is caused to be lowered to the low potential sustain voltage Vs_low by conducting the second switch SUS_DN.

That is, if the second switch SUS_DN is conducted, a current path 17 from the panel through the second switch is formed, and the low potential sustain voltage Vs_low is applied to the scan electrode Y.

As such, the sustain pulse can be applied to the scan electrode Y by driving the charging switch ER_UP, the recovering switch ER_DN, and the first and second switches SUS_UP and SUS_DN.

Since the construction of the plasma display apparatus as above can apply the set-up signal R_up, the set-down signal R_dn, the scan pulse scp, and the sustain pulse sus using a voltage source for applying the high potential sustain voltage Vs_high and a voltage source for applying the low potential sustain voltage Vs_low, the construction of the end of voltage source can be simplified.

Additionally, since signals for driving the plasma display panel can be applied without providing a separate cutoff switch, cost required to configure the driving circuit of the plasma display panel can be reduced and the circuit efficiency can be improved in comparison with the prior art.

In particularly, since the magnitude of the first voltage source V1 and the second voltage source V2 used to form the driving signals is not fixed, and can be freely formed by circuit designers, the first voltage source V1 and the second voltage source V2 can be varied according to the property of the plasma display apparatus.

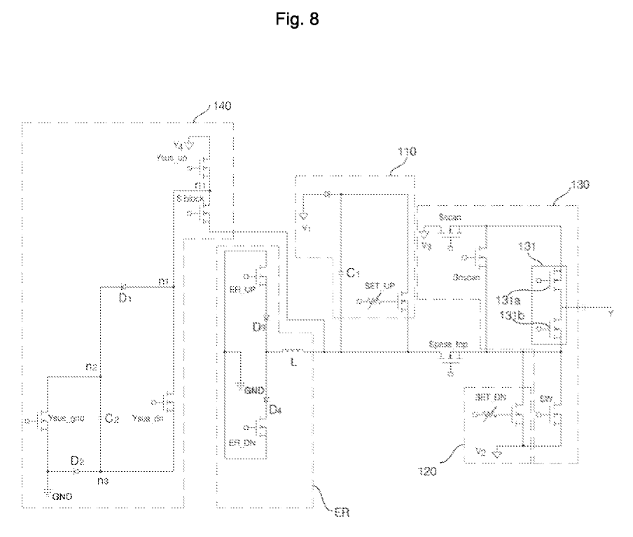

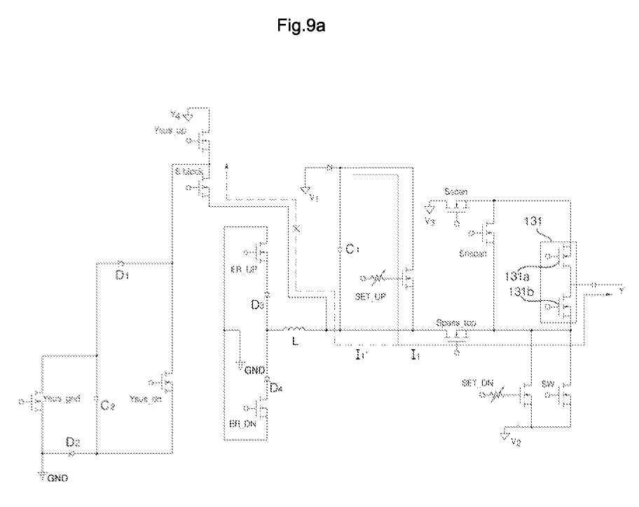

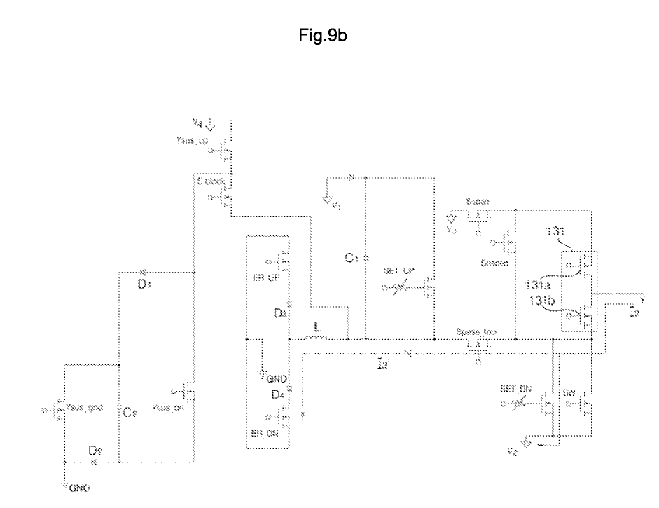

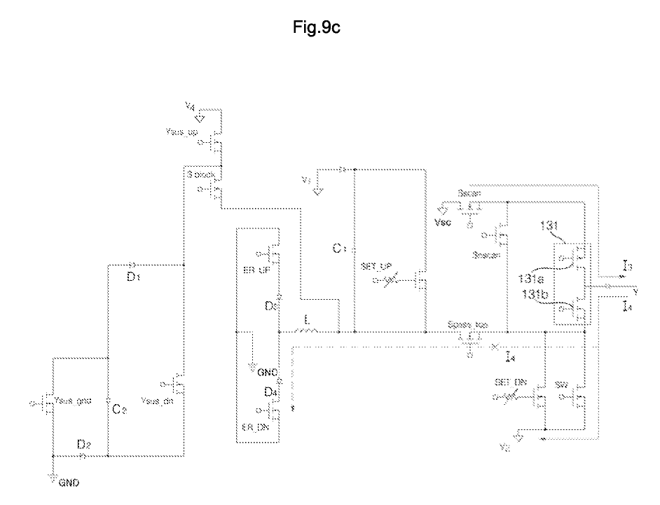

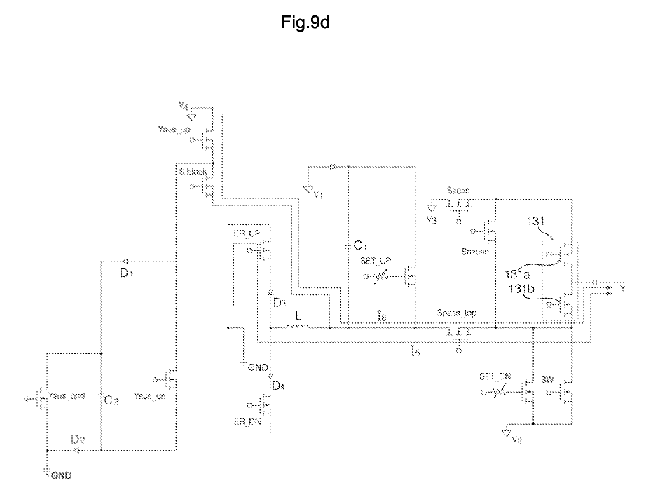

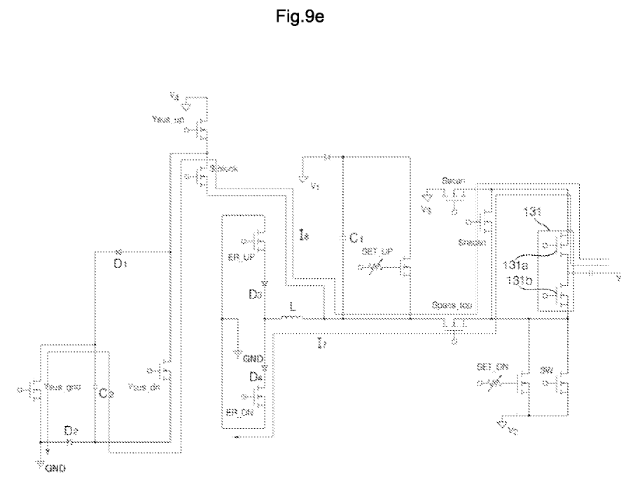

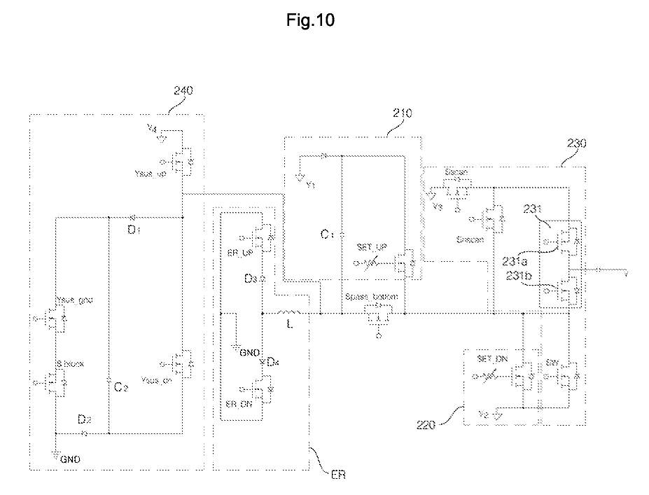

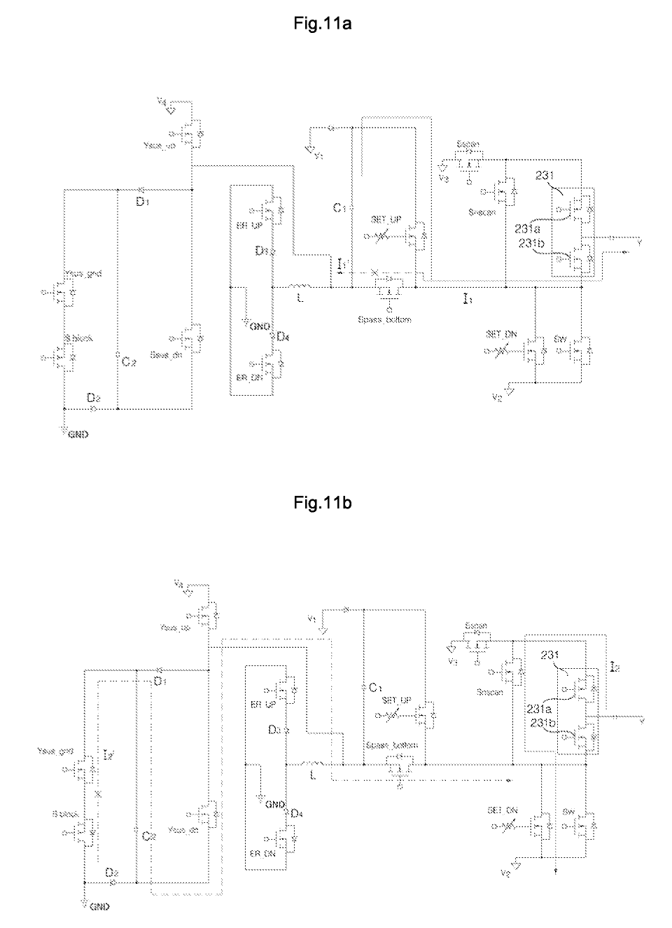

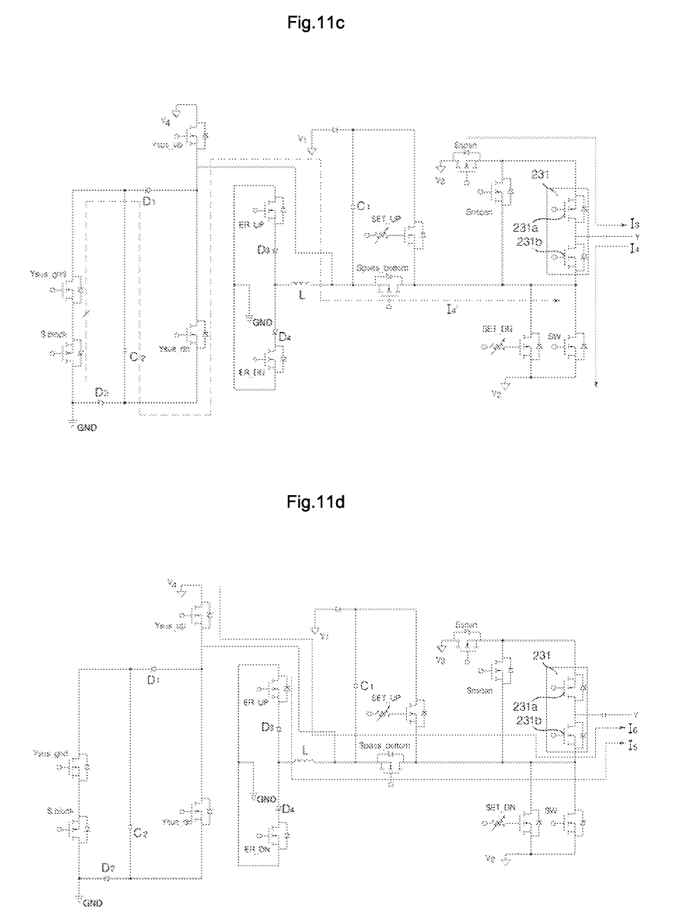

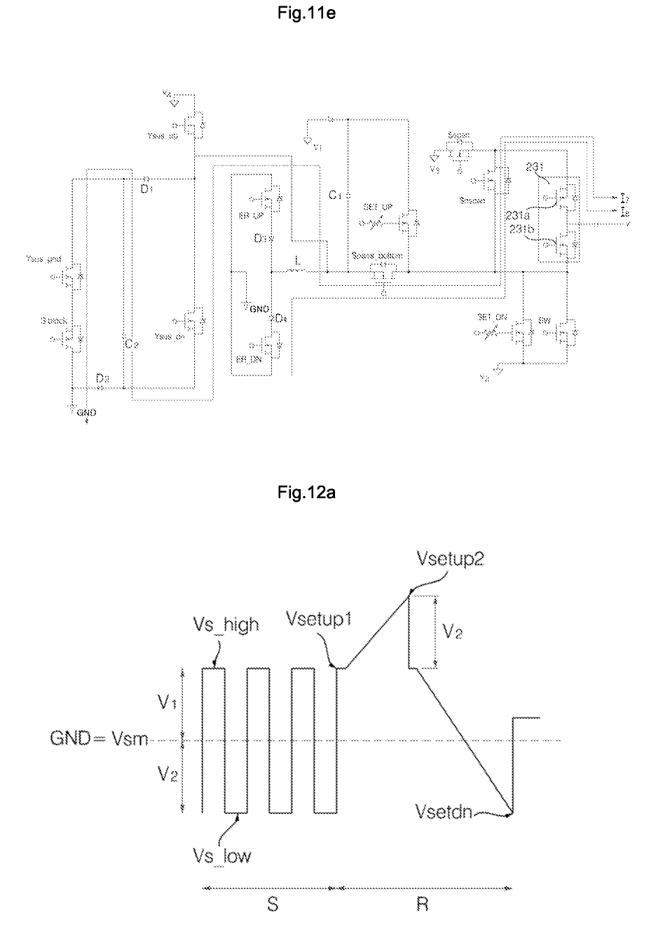

FIG. 8 is a view illustrating a plasma display apparatus according to a second embodiment of the present invention, FIGS. 9A through 9E are views illustrating a current flow of the plasma display apparatus according to the second embodiment of the present invention, FIG. 10 is a view illustrating a plasma display apparatus according to a third embodiment of the present invention, and FIGS. 11A and 11b are views illustrating a current flow of the plasma display apparatus according to the third embodiment of the present invention.

The second embodiment of the plasma display apparatus of the present invention includes a set-up driver 110 for applying a set-up signal R_up, a set-down driver 120 for applying a set-down signal R_dn, an energy recovering unit ER for recovering a reactive current stored in the scan electrode Y and reusing it, a sustain driver 140 connected to the energy recovering unit and for applying a sustain pulse sus, and a scan driver 130 for applying a scan pulse scp, as shown in FIG. 8.

The set-up driver 110 includes a set-up switch SET_UP connected to a first voltage source V1, which is an external voltage source of applying the set-up voltage Vsetup, and for applying the set-up signal R_up to the scan electrode Y as conducted.

Since the set-up switch SET_UP is connected to a variable resistor, the set-up signal R_up is allowed to be applied to the scan electrode Y in a positive (+) ramp waveform by adjusting the variable resistor connected to the set-up switch SET_UP.

A capacitor C1 is connected in parallel with the set-up switch SET_UP; one end of the capacitor C1 is connected to the first voltage source V1 of applying the set-up voltage Vsetup, and the other end is connected to the sustain driver 140.

The set-down driver 120 includes a set-down switch SET_DN connected to the second voltage source V2 of applying the set-down voltage Vsetdn. The set-down switch SET_DN is connected to the variable resistor likewise to the set-up switch SET_UP, the set-down signal R_dn is allowed to be applied to the scan electrode Y in a ramp waveform by adjusting the variable resistor.

The scan driver 130 includes one or more scan switches Sscan, Snscan for applying the scan voltage Vsc, a scan IC 131, and a scan pulse switch SW for applying the scan pulse scp.

One end of the first scan switch Sscan is connected to a third voltage source V3 for applying the scan voltage Vsc, and the other end is connected to the scan IC 131.

The second scan switch Snscan operates complementarily with the first scan switch Sscan; one end of the second scan switch is connected to the scan IC 131 and the other end is connected to the set-down driver 120.

The scan IC 131 includes a high switch 131a for forming a path of the set-up signal R_up applied to the scan electrode Y and a low switch 131b for forming a path of the set-down signal R_dn.

If the address period A is initiated, the first scan switch Sscan is conducted and the scan voltage Vsc is applied to the scan electrode Y, and as result thereof, the scan electrode Y has a scan bias voltage Vby.

One end of the scan pulse switch SW is connected to the scan IC 131, and the other end is connected to the second voltage source V2 for applying the lowest scan voltage −Vy.

At this time, since the scan pulse switch SW and the set-down switch SET_DN are connected to the same voltage source V2, the lowest scan voltage −Vy and the set-down voltage Vsetdn is formed equally.

Accordingly, if the set-down switch SET_DN or the scan pulse switch SW is conducted, the voltage of the scan electrode Y is lowered up to the set-down voltage Vsetdn or the lowest scan voltage −Vy.

However, the lowest scan voltage −Vy and set-down voltage Vsetdn can be formed differently by changing the circuit construction or adjusting ON/OFF timing of the switch.

That is, in case that the scan pulse switch SW and the set-down switch SET_DN are connected to a different external voltage source, or a compensation circuit for compensating the voltage difference between the lowest scan voltage −Vy and set-down voltage Vsetdn is provided, the lowest scan voltage −Vy and set-down voltage Vsetdn can be formed differently.

The energy recovering unit ER includes an inductor L for forming a resonant current, and one or more switches ER_UP and ER_DN connected to the inductor and recovering a reactive current from the scan electrode Y.

The switches ER_UP and ER_DN includes a recovering switch ER_DN for recovering energy stored in the scan electrode Y and a charging switch ER_UP for applying the recovered energy to the scan electrode Y. At this time, diodes D3 and D4 are connected to one end of the charging/recovering switches ER_UP and ER_DN, respectively, to prevent reverse current flow of the resonant current.

In the half sustain driving type, generally, the high potential sustain voltage Vs_high and the low potential sustain voltage Vs_low have the magnitude of the half of the sustain voltage Vs, and the sign of the two voltages is opposite to each other.

The voltage recovered to the energy recovering unit ER is set up with a middle level of the high potential sustain voltage Vs_high and the low potential sustain voltage Vs_low; the plasma display apparatus of the present invention performs the half sustain driving and thus the voltage recovered to the energy recovering unit ER is set to a base voltage GND.

Therefore, the energy recovering unit ER of this embodiment may connect the base voltage GND between the charging switch ER_UP and the recovering switch ER_DN even without providing a separate capacitor.

The sustain driver 140 includes a first switch Ysus_up connected to a fourth voltage source V4 such that a positive (+) external voltage source is applied to the scan electrode Y as conducted, a capacitor C2 charged with a current as the first switch is conducted, and a second switch and third switches Ysus_dn and Ysus_gnd operating complementarily with the first switch and discharging a current from the scan electrode Y and capacitor C2 as conducted.

The drain of the first switch Ysus_up is connected to a fourth voltage source V4 for applying the positive (+) voltage Vs/2, and the second switch Ysus_dn is connected to the same node n1 as the source of the first switch. At this time, the fourth voltage source has the magnitude of the half (Vs/2) of the sustain voltage to apply the high potential sustain voltage Vs_high.

One end of the capacitor C2 is connected to the same node n2 of the source of the second switch Ysus_dn, the drain of the third switch Ysus_gnd and the other end of the capacitor C2 are connected to the same node n3, and the third switch Ysus_gnd and the capacitor are connected in parallel with each other. At this time, the second and third switches Ysus_dn and Ysus_gnd are connected to the base voltage GND.

If the recovering switch ER_DN is conducted, a current is recovered from the scan electrode Y, and if the second and third switches Ysus_dn and Ysus_gnd are conducted, a current is flowed out of the scan electrode Y and thereby the voltage of the scan electrode Y is reduced from the high potential sustain voltage Vs_high to the low potential sustain voltage Vs_low.

If the second and third switches Ysus_dn and Ysus_gnd are conducted, a current discharged from the capacitor C2 can flow into the first switch Ysus_up.

That is, since the voltage of the node n1 at which the first switch Ysus_up and the set-up driver 110 are connected is higher than that of the capacitor C2, a current is flowed from the capacitor C2 into the first switch Ysus_up if the second and third switches Ysus_dn and Ysus_gnd are conducted, and thereby the voltage applied to the sustain electrode Y can not be lowered up to the low potential sustain voltage Vs_low.

To prevent this, a reverse current prevention element such as a diode D1 (hereinafter, referred to as a “first diode”) is connected between the first switch Ysus_up and the capacitor C2 so as to prevent a current discharged from the capacitor C2 from flowing back to the first switch Ysus_up as the second and third switches Ysus_dn and Ysus_gnd are conducted.

The anode of the first diode D1 is connected to the first switch Ysus_up (n1), and its cathode is connected to one end of the capacitor (n3).

In addition, a current discharged from the capacitor C2 may flow back when the second and third switches Ysus_dn and Ysus_gnd are conducted to apply the waveform of a negative low potential sustain voltage Vs_low to the scan electrode Y

In this case, since a current path from the scan electrode Y through the second switch Ysus_dn, the capacitor C2, and the third switch Ysus_gnd can not be formed normally, the normal sustain pulse sus fails to be applied to the scan electrode Y.

To prevent this, a reverse current prevention element such as a diode D2 (hereinafter, referred to as a “second diode”) is provided; the anode of the diode D2 is connected to the one end of the capacitor C2, and its cathode is connected to the source of the third switch Ysus_gnd.

The sustain driver 140 is connected to the energy recovering unit ER and simultaneously to the set-up driver 110 to apply the sustain pulse sus to the scan electrode Y.

Accordingly, when the set-up switch SET_UP is conducted and the set-up voltage Vsetup is applied to the scan electrode Y, a current having passed through the set-up switch may flow into the sustain driver 140 as well as the scan electrode Y.

If the set-up voltage Vsetup is applied to the sustain driver 140, the normal set-up signal R_up can not be applied to the scan electrode Y, and therefore, the sustain driver 120 includes a path-blocking switch Sblock for blocking the set-up signal.

The path-blocking switch Sblock is connected to the first switch Ysus_up in the push and pull type to pass the current from the first switch Ysus_up toward the scan electrode Y and to block the current flowing from the set-up switch SET_UP into the first switch Ysus_up.

That is, since the set-up switch SET_UP of applying the set-up signal R_up to the panel directly between the first switch Ysus_up and path-blocking switch Sblock, a current flowing into the sustain driver 140 as conducted can be blocked.

Since only the discharging current is flowed into the path-blocking switch Sblock, the amount of a current passing through the path-blocking switch Sblock is small and thereby the sustain driver 140 may be constructed using a small capacity of switching elements.

In addition, since the path-blocking switch Sblock is connected to the first switch Ysus_up in the push and pull type, applying the sustain pulse sus falling from the high potential sustain voltage Vs_high to the low potential sustain voltage Vs_low is accomplished similarly to the prior art.

Therefore, a driving circuit for applying driving waveforms to the scan electrode can be simply constructed using the path-blocking switch Sblock without the need of varying ON/OFF timing of a separate switch.

If the set-down switch SET_DN or the scan pulse switch SW are conducted in this embodiment, the voltage of the scan electrode Y is lowered up to the set-down voltage Vsetdn or the lowest scan voltage −Vy.

At this time, since one end of the set-down switch SET_DN and one end of the scan pulse switch SW are connected to the sustain driver 140 and energy recovering unit ER, the voltage of the scan electrode Y can not be lowered up to the set-down voltage Vsetdn or the lowest scan voltage −Vy.

Accordingly, the plasma display apparatus of this embodiment further includes a cutoff switch Spass_top so that the scan electrode Y may cut off the current path failing to reach the set-down voltage Vsetdn or the lowest scan voltage −Vy during the period when the set-down signal R_dn is applied or the address period A

Applying the driving waveforms to the scan electrode Y using the plasma display apparatus according to the second embodiment of the present invention configured as above will be described using a current path as follows.

If the reset period R is initiated, the first switch Ysus_up of the sustain driver 140 is conducted and the voltage equal to the high potential sustain voltage Vs_high is applied to the scan electrode Y.

Then, if the set-up switch SET_UP is conducted, a current path from the first voltage source V1 of supplying the set-up voltage Vsetup, through the set-up switch SET_UP, the cutoff switch Spass_top, and the scan IC 131 to the scan electrode Y is formed, and accordingly the set-up signal R_up is applied, as shown in FIG. 9A.

At this time, the high switch 131a of the scan IC 131 is turned on, and its low switch 131b is turned off. Therefore, the set-up signal R_up passes through a body diode of the low switch 131b and is applied to the scan electrode Y.

At this time, a current having passed through the set-up switch SET_UP flows to the sustain driver 140 (11′); a current flowing into the sustain driver 140 is blocked by the path-blocking switch Sblock.

The set-up switch SET_UP is turned off and the set-down switch SET_DN is turned off to apply the set-down signal R_dn. If the set-up switch SET_UP is turned off, the voltage of the scan electrode Y drops up to the high potential sustain voltage Vs_high, and if the set-down switch SET_DN is turned on, a current path 12 from the scan electrode Y to the second voltage source V2 is formed and the set-down voltage Vsetdn is applied to the scan electrode Y, as shown in FIG. 9B.

If the set-down switch SET_DN is conducted, a current path 12′ from the scan electrode Y to the recovering switch ER_DN of the energy recovering unit ER is formed.

If the current path 12′ from the scan electrode Y to the recovering switch ER_DN is formed, a negative (−) set-down voltage Vsetdn can not be applied to the scan electrode.

Accordingly, the current path 12′ from the scan electrode Y to the recovering switch ER_DN is blocked by the cutoff switch Spass_top, and thus the set-down signal R_dn can be applied stably.

Additionally, since the set-up switch SET_UP and set-down switch SET_DN are all constructed with lamp switches, a ramp waveform of voltage is applied to the scan electrode Y when the set-up switch SET_UP or set-down switch SET_DN is conducted.

If the address period A is initiated, the first scan switch Sscan is turned on, and at the same time, the second scan switch Snscan is turned off. If the first scan switch Sscan is turned on, the current 13 having passed through the first scan switch Sscan passes through the high switch 131a of the scan IC 131 and is applied to the scan electrode Y as shown in FIG. 9C. Accordingly, the scan voltage Vsc is applied to the scan electrode, and the scan electrode Y has the bias voltage Vby.

The lowest scan voltage −Vy is allowed to be applied to the scan electrode Y by conducting the scan pulse switch SW provided in the scan driver 130 so as to apply the scan pulse scp to the scan electrode Y.

If the scan pulse switch SW is conducted, a current path 14 from the scan electrode Y to the second voltage source V2 is formed, and thereby the lowest scan voltage −Vy is applied to the scan electrode Y.

At this time, if a current path 14′ from the scan electrode Y to the recovering switch ER_DN of the energy recovering unit ER is formed, the voltage of the scan electrode Y is not reduced up to the lowest scan voltage −Vy. However, if the cutoff switch Spass_top is provided as above, the current path 14′ from the scan electrode Y to the energy recovering unit ER is blocked.

If the sustain period S is initiated, first of all, a positive (+) high potential sustain voltage Vs_high is applied to the scan electrode Y (15) by turning on the charging switch ER_UP of the energy recovering unit ER.

At this time, since the voltage applied to the scan electrode Y does not reach two times the voltage recovered by resonance due to voltage drop from the parasitic resistance and switches or diodes, the charging switch ER_UP is turned on and then turns on the first switch Ysus_up (16).

That is, current paths 15 and 16 are formed as shown in FIG. 9D, and the sustain pulse sus rising to the scan electrode Y is applied; if the charging switch ER_UP is turned on, the voltage of the scan electrode Y rises from the low potential sustain voltage Vs_low up to around the high potential sustain voltage Vs_high.

At this time, if first switch Ysus_up is subsequently turned on, a differential component from the voltage formed by resonance to the high potential sustain voltage Vs_high is compensated, and thereby the high potential sustain voltage Vs_high is applied to the scan electrode Y, and the scan electrode Y maintains the high potential sustain voltage Vs_high while the first switch Ysus_up is conducted.

On the contrary, the voltage applied to the scan electrode Y is allowed to be recovered so as to be used when the next sustain pulse is applied by turning on the second recovering switch ER_dn before turning on the second and the third switch Ysus_dn and Ysus_gnd.

That is, if the recovering switch ER_DN is turned on as shown in FIG. 9E, a current path 17 from the scan electrode Y through the inductor L to the recovering switch ER_DN is formed and thereby reactive current of the scan electrode Y is recovered.

Recovering the current is accomplished by resonance between the scan electrode Y and the inductor L; although the recovering switch ER_DN is conducted, the voltage of the scan electrode Y can not be reduced up to the negative (−) low potential sustain voltage Vs_low due to voltage drop from the parasitic resistant components existed on the circuit or circuit elements.

Accordingly, if the second and third switches Ysus_dn and Ysus_gnd are conducted, a current path 18 from the scan electrode Y through the second and third switches Ysus_dn and Ysus_gnd is formed, and the differential component between the voltage formed by the resonance and the low potential sustain voltage Vs_low is compensated, and thereby the voltage of the scan electrode Y is reduced up to the low potential sustain voltage Vs_low.

Although the construction of the driving circuit for applying the driving waveforms to the scan electrode Y has been described as above, it is possible to construct a circuit for applying the sustain pulse sus to the sustain electrode Z using the sustain driver 120 and energy recovering unit ER.

That is, it is possible to apply the same sustain pulse sus as being applied to the scan electrode Y to the sustain electrode Z using the same sustain driver 120 and energy recovering unit ER.

A third embodiment of the plasma display apparatus of the present invention will be described as follows with reference to FIG. 10. This embodiment, likewise to the second embodiment, also includes a set-up driver 210 for applying a set-up signal R_up, a set-down driver 220 for applying a set-down signal R_dn, an energy recovering unit ER for recovering reactive current and reusing it, a sustain driver 240 connected to the energy recovering unit and for applying a sustain pulse sus to the scan electrode Y, and a scan driver 230 for applying a scan pulse scp.

The construction of the set-up driver 210, set-down driver 220, energy recovering unit ER, and scan driver 230 is equal to that of the second embodiment illustrated in FIG. 7.

The set-up driver 210 includes a set-up switch SET_UP connected to the first voltage source V1 and for applying the set-up signal R_up, and the set-down driver 220 includes a set-down switch SET_DN connected to the second voltage source V2 and for applying the set-down signal R_dn. The set-up switch SET_UP and set-down switch SET_DN both apply a ramp waveform of signal.

The scan driver 230 includes one or more scan switches Sscan and Snscan for applying the scan voltage Vsc as conducted, a scan IC 231, and a scan pulse switch SW for applying the scan pulse scp.

The energy recovering unit ER includes an inductor L for forming resonant current, a charging switch ER_UP for recovering reactive current, and a recovering switch ER_DN for applying the recovered reactive current to the scan electrode Y.

At this time, reverse current prevention elements such as diodes D3 and D4 are connected to one end of the charging/recovering switches ER_UP and ER_DN, respectively, to prevent reverse current flow of the resonant current.

Although the energy recovering unit ER provided in this description will be based on a Weber circuit for its description, it should be appreciated by those skilled in the art that this energy recovering unit may be replaced by any other energy recovering units.

The sustain driver 240 includes a first switch Ysus_up connected to a fourth voltage source V4 and applying a positive (+) high potential sustain voltage Vs_high having the magnitude of the half of the sustain voltage Vs to the scan electrode Y, a capacitor C2 charged with a current as the first switch is conducted, and a second switch and a third switch Ysus_dn and Ysus_gnd operating complementarily with the first switch and discharging a current from the scan electrode Y and capacitor C2 as conducted.

One end of the capacitor C2 is connected to the second switch Ysus_dn, and the other end is connected to the first switch Ysus_up. The second and third switches Ysus_dn and Ysus_gnd are connected in parallel with each other, with the capacitor C2 placed therebetween. At this time, one end of the second and third switches is connected to earth GND.

If the first switch Ysus_up is conducted, the positive (+) high potential sustain voltage Vs_high is applied from the fourth voltage source V4 through the first switch Ysus_up to the scan electrode Y.

At the same time, a current is applied from the fourth voltage source V4 to the capacitor C2, and thereby the capacitor C2 has a voltage as high as the high potential sustain voltage Vs_high.

If the second and third switches Ysus_dn and Ysus_gnd are conducted, a current is flowed out of the scan electrode Y, and thereby the voltage of the scan electrode Y is reduced from the positive (+) high potential sustain voltage Vs_high to the negative (−) low potential sustain voltage Vs_low.

A reverse current prevention element D1 is provided between the first switch Ysus_up and the capacitor C2 so as to prevent a current discharged from the capacitor from flowing back to the first switch Ysus_up as the second and third switches Ysus_dn and Ysus_gnd are conducted.

In addition, a reverse current prevention element D2 is provided so as to prevent the current toward earth GND from flowing back as the second and third switches Ysus_dn and Ysus_gnd are conducted.

The sustain driver 240 is connected to the energy recovering unit ER and simultaneously to the set-up driver 210 to apply the sustain pulse sus to the scan electrode Y.

Accordingly, when the set-up switch SET_UP is conducted and the set-up voltage Vsetup is applied to the scan electrode Y, a current having passed through the set-up switch SET_UP may flow into the sustain driver 240 as well as the scan electrode Y.

If the set-up voltage Vsetup is applied to the sustain driver 140, the normal set-up signal R_up can not be applied to the scan electrode Y, and therefore, a cutoff switch Spass_bottom is provided between the sustain driver 240 and the set-up driver 210.

Additionally, when the set-down signal R_dn or scan pulse scp is applied, a body diode connected to the second and third switches Ysus_dn and Ysus_gnd and the cutoff switch Spass_bottom is conducted if the voltage of the scan electrode Y is reduced, and thereby a current may be flowed from the sustain driver 240.

In this case, although the set-down switch SET_DN or scan pulse switch SW is conducted, voltage drop is not done to the scan electrode Y below the low potential sustain voltage Vs_low, and thus the set-down signal R_dn or scan pulse scp can not be applied normally.

Accordingly, a path-blocking switch Sblock, which blocks the path of the current flowing back to the scan electrode Y through the third switch Ysus_gnd, is provided in the sustain driver 240 to block the current flowed from the sustain driver 240 to the scan electrode Y upon applying the set-down signal R_dn or scan pulse scp.

The path-blocking switch Sblock is connected to the third switch Ysus_gnd in the push and pull type. Accordingly, the path-blocking switch passes the current flowing from the capacitor C2 to the third switch Ysus_gnd during the sustain period S to apply the sustain pulse sus falling from the high potential sustain voltage Vs_high to the low potential sustain voltage Vs_low, and blocks the current from the third switch Ysus_gnd toward the scan electrode Y during the reset period R or address period A.

Since only the discharging a current generated as the second and third switches Ysus_dn and Ysus_gnd are conducted passes through the path-blocking switch Sblock, the sustain driver 240 may be constructed using switching elements having the capacity smaller than that of the prior art.

In particular, since the number of switches through which the discharging current passes is reduced and the number of the current paths is also decreased, distortion of signals having passed through the path-blocking switch Sblock and the fall of energy recovering rate can be prevented.

Furthermore, since the number of switching elements is lessened, cost required to construct the driving circuit can be reduced, and therefore, manufacturing cost of the plasma display apparatus can also be decreased.

Therefore, a driving circuit for applying driving waveforms to the scan electrode can be simply constructed using the path-blocking switch Sblock without the need of varying ON/OFF timing of a separate switch.

Applying the driving waveforms to the scan electrode Y using the plasma display apparatus according to the third embodiment of the present invention configured as above will be described as follows with reference to FIGS. 11A to 11E.

To begin with, if the reset period R is initiated, the first switch Ysus_up of the sustain driver 240 is conducted and thereby the voltage equal to the high potential sustain voltage Vs_high is applied to the scan electrode Y.

Then, if the set-up switch SET_UP is conducted, a current path 11 from the first voltage source V1 of supplying the set-up voltage Vsetup, through the set-up switch SET_UP and the scan IC 131 to the scan electrode Y is formed, and accordingly the set-up signal R_up is applied, as shown in FIG. 11A.

At this time, the high switch 131a of the scan IC 131 is turned on, and its low switch 131b is turned off, and thereby the set-up signal R_up passes through the body diode of the low switch 131b and is applied to the scan electrode Y.

At this time, the current 11′ flowing from the set-up switch SET_UP into the sustain driver 240 is blocked by the cutoff switch Spass_bottom.

The set-up switch SET_UP is turned off and the set-down switch SET_DN is turned off to apply the set-down signal R_dn. If the set-up switch SET_UP is turned off, the voltage of the scan electrode Y falls up to the high potential sustain voltage Vs_high.

Then, if the set-down switch SET_DN is conducted, a current path 12 from the scan electrode Y to the second voltage source V2 is formed, and thereby the set-down voltage Vsetdn is applied to the scan electrode Y, as shown in FIG. 11B. The set-down voltage Vsedn is formed equally to the lowest scan voltage −Vy in this description.

If the set-down switch SET_DN is conducted, a current 12′ flows from the scan electrode Y into the energy recovering unit ER, or from the sustain driver 240 into the panel, and in this case the negative (−) set-down voltage Vsetdn can be applied to the scan electrode Y.

However, if the path-blocking switch Sblock is provided as this embodiment, a current from the sustain driver 240 into the scan electrode Y is blocked by the path-blocking switch Sblock, and thus the set-down signal R_dn can be applied stably.

If the address period A is initiated, the first scan switch Sscan is turned on, and at the same time the second scan switch Snscan is turned off, and thus the scan voltage Vsc is applied to the scan electrode Y and thereby the scan electrode Y has the scan bias voltage Vby.

The current 13 having passed through the first scan switch Sscan passes through the high switch 131a of the scan IC 131 and is applied to the scan electrode Y as shown in FIG. 11C.

Since the set-down voltage Vsetdn applied to the scan electrode Y upon the start of the address period A is greater than the scan voltage Vsc applied as the first scan switch Sscan is conducted, the scan electrode Y has a negative (−) bias voltage Vby.

If the scan pulse switch SW is conducted, a current path 14 from the scan electrode Y to the negative (−) third voltage source V3 is formed, and thereby the lowest scan voltage −Vy is applied to the scan electrode Y.

At this time, a current 14′ flows from the sustain driver 240 into the scan electrode Y, and thereby the voltage of the scan electrode Y could not be reduced up to the lowest scan voltage −Vy.

Accordingly, if the path-blocking switch Sblock is provided in the sustain driver 240, a current 14′ flowing from the sustain driver 240 to the scan electrode Y is blocked by the path-blocking switch Sblock.

If the sustain period S is initiated, a positive (+) high potential sustain voltage Vs_high is applied to the scan electrode Y (15) by turning on the charging switch ER_UP of the energy recovering unit ER, as shown in FIG. 11D.

At this time, since the recovered voltage is resonated due to voltage drop from the parasitic resistance existed on the current path and switches or diodes, and thereby the voltage as high as two times the recovered voltage can not be applied to the scan electrode Y, the charging switch ER_UP is turned on and then the first switch Ysus_up is turned on (16).

The second and third switches Ysus_dn, Ysus_gnd should be turned on so that the reactive current of the scan electrode Y may be recovered; the voltage applied to the scan electrode Y is recovered with the recovering switch ER_DN turned on before the second and third switches Ysus_dn and Ysus_gnd is turned on so as to be capable of being used when the next sustain pulse is applied.

That is, if the recovering switch ER_DN is turned on as shown in FIG. 11E, a current path 17 from the scan electrode Y through the inductor L to the recovering switch ER DN is formed and thereby reactive current of the scan electrode Y is recovered.

Since the recovery of the current is performed by resonance between the scan electrode Y and inductor L, the voltage of the scan electrode Y can not be reduced up to the negative lowest scan voltage −Vy although the recovering switch ER_DN is conducted.

Accordingly, if the second and third switches Ysus_dn and Ysus_gnd are conducted, a current path 18 from the scan electrode Y through the second and third switches Ysus_dn and Ysus_gnd is formed, and thereby the voltage of the scan electrode Y is reduced up to the negative lowest sustain voltage Vs_low.

At this time, the current 18 having passed from the capacitor C2 through the third switch Ysus_gnd passes through and flows out the body diode connected to the path-blocking switch Sblock.

In the plasma display apparatus having a circuit construction for applying driving waveforms to the plasma display apparatus as mentioned above, since the number of elements used is reduced compared to the prior art, or a separate switching element for blocking the current is not needed, cost required to construct the circuit may be saved, and since the number of switches through which a current generated to apply driving waveforms passes is decreased, signal distortion may be lessened.

Additionally, since the resonant current generated when energy is recovered doesn't pass through the path-blocking switch Sblock and thereby the path of the resonant current is reduced and the energy recovering efficiency is raised, power consumption required to drive the plasma display apparatus can be reduced.

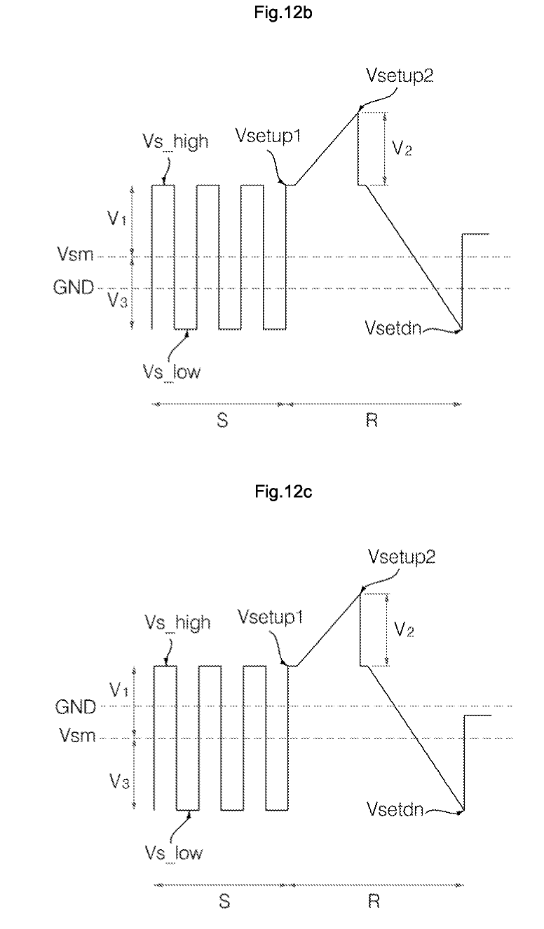

A driving method of the plasma display apparatus constructed as above will be described as follows with reference to FIGS. 12A to 12C.

As shown in FIGS. 12A to 12C, if the reset period R is initiated, a voltage rising from the low potential sustain voltage Vs_low to the first set-up voltage Vsetup1 is applied to the first electrode. At this time, the first electrode can be implemented with a scan electrode, in case of a three-electrode AC type plasma display apparatus.

At this time, the first set-up voltage Vsetup1 is formed equally to the high potential sustain voltage Vs_high.

Then, a voltage rising from the first set-up voltage Vsetup1 to the second set-up voltage Vsetup2 in a ramp waveform is supplied to the first electrode, and if the voltage of the first electrode reaches the second set-up voltage Vsetup2, then the voltage of the first electrode is reduced from the second set-up voltage Vsetup2 to the first set-up voltage Vsetup1.

Subsequently, a voltage falling from the first set-up voltage Vsetup1 to the set-down voltage Vsetdn in a ramp waveform is applied to the first electrode; the set-down voltage Vsetdn is formed equally to the low potential sustain voltage Vs_low.

At this time, a ground level GND may be set to a middle voltage Vsm (hereinafter, referred to as a “sustain central voltage”) between the high potential sustain voltage Vs_high and low potential sustain voltage Vs_low as shown in FIG. 12A; in this case, the magnitudes of the absolute values of the high potential sustain voltage Vs_high and low potential sustain voltage Vs_low are the same, and their polarities are opposite to each other.

In addition, the sustain central voltage Vsm, as shown in FIG. 12B, may be set to a positive voltage level, and at this time, the absolute value of the high potential sustain voltage Vs_high is greater than that of the low potential sustain voltage Vs_low.

On the contrary, the sustain central voltage Vsm, as shown in FIG. 12C, may be set to a negative voltage level, and at this time, the absolute value of the high potential sustain voltage Vs_high is formed smaller than that of the low potential sustain voltage Vs_low.

Additionally, a voltage difference V1 between the sustain central voltage Vsm and the first set-up voltage Vsetup1 is formed equally to a voltage difference V2 between the first set-up voltage and the second set-up voltage Vsetup2, and a voltage difference V3 between the sustain central voltage Vsm and the set-down voltage Vsetdn is also formed equally to the voltage difference between the sustain central voltage Vsm and the first set-up voltage Vsetup1 and/or the voltage difference V2 between the first set-up voltage and the second set-up voltage.

It is to be understood by those skilled in the art that the invention may be embodied in several forms without departing from the spirit of essential characteristics thereof, and the scope of the present invention should be defined by the appended claims rather than by the description preceding them.

What is claimed is:

1. A plasma display apparatus comprising:
a set-up switch SET_UP for applying a set-up signal R_up to scan ICs 31, 131, and 231, and
a set-down switch SET_DN for applying a set-down signal R_dn to scan ICs 31, 131, and 231,
wherein the set-up switch SET_UP is connected to the scan ICs 31, 131, and 231, and the set-down switch SET_DN is connected to an inductor L of an energy recovering unit ER for recovering a reactive current of a scan electrode Y.

2. The plasma display apparatus of claim 1, wherein capacitors C and Cl are connected in parallel to the set-up switch SET_UP.

3. The plasma display apparatus of claim 1, wherein the energy recovering unit ER comprises one or more switch ER_UP and ER_DN and an inductor L for recovering a current of the scan electrode Y during a sustain period, and a source capacitor Cs for storing the reactive current recovered from the scan electrode Y.

4. The plasma display apparatus of claim 3, wherein the source capacitor Cs is connected to a negative voltage source for forming the set-down signal R_dn.

5. The plasma display apparatus of claim 3, further comprising:
sustain drivers 40 and 140 comprises
a first switch SUS_UP and a second switch SUS_DN connected to the energy recovering unit ER to apply a sustain pulse to the scan electrode Y.

6. The plasma display apparatus of claim 5, wherein the first switch SUS-UP is connected to a positive voltage source for forming the set-up signal R_up.

7. The plasma display apparatus of claim 5, wherein the second switch SUS-DN is connected to a negative voltage source for forming the set-down signal R_dn.

8. The plasma display apparatus of claim 6, wherein a voltage difference between the positive voltage source and the negative voltage source is constant, and
the absolute values of the respective voltage sources are equal to each other.

9. The plasma display apparatus of claim 1, wherein the energy recovering unit ER comprises an inductor L for forming a resonant current and at least one switch ER_UP and ER_DN connected to the inductor L to recover a reactive current from the scan electrode Y.

10. The plasma display apparatus of claim 9, wherein a cutoff switch Spass_top is connected to the set-up switch SET_UP and the set-down switch SET_DN therebetween.

11. The plasma display apparatus of claim 9, further comprising:
a sustain driver 240 comprises
a first switch Ysus_up connected to the energy recovering unit ER to apply a positive external voltage source to the panel, a capacitor C2 charged with a current as the first switch Ysus_up is conducted, and a second and third switches Ysus_dn and Ysus_gnd for operating complementarily with the first switch Ysus_up to discharge a current from the scan electrode Y and the capacitor C2 as conducted.

12. The plasma display apparatus of claim 11, wherein the capacitor C2 and the second switch and the third switches Ysus_dn and Ysus_gnd are connected in parallel to one another.

13. The plasma display apparatus of claim 12, further comprising a reverse current prevention element for preventing a current flowing toward earth from flowing back to the capacitor C2 as the second and third switches Ysus_dn and Ysus_gnd are conducted.

14. The plasma display apparatus of claim 11, further comprising reverse current prevention elements D1 and D2 for preventing a current discharged from the capacitor C2 from flowing back to the first switch Ysus_up as the second and third switches Ysus_dn and Ysus_gnd are conducted.

15. The plasma display apparatus of claim 11, wherein the sustain driver 240 further comprises a path-blocking switch Sblock connected to the first switch Ysus_up in a push and pull type.

16. The plasma display apparatus of claim 11, wherein the sustain driver 240 further comprises a path-blocking switch Sblock connected to the third switch Ysus_gnd in a push and pull type.

17. The plasma display apparatus of claim 15, wherein a cutoff switch Spass_bottom is connected to the first switch Ysus_up and the set-up switch SET_UP therebetween.

18. The plasma display apparatus of claim 16, wherein the energy recovering unit ER is connected to the path-blocking switch Sblock.

19. A driving method of a plasma display apparatus comprising a reset period and a sustain period, the driving method comprising:
supplying to a first electrode Y a voltage rising from a low potential sustain voltage Vs_low to a first set-up voltage Vsetup1 during the reset period;
supplying to the first electrode Y a voltage rising from the first set-up voltage Vsetup1 to a second set-up voltage Vsetup2 in a ramp waveform;
reducing a voltage of the first electrode Y from the second set-up voltage Vsetup2 to the first set-up voltage Vsetup1; and
supplying to the first electrode Y a voltage falling from the second set-up voltage Vsetup2 to a set-down voltage Vsetdn in a ramp waveform,
wherein the first set-up voltage Vsetup1 is equal to a high potential sustain voltage Vs_high.

20. The driving method of claim 19, wherein a level of the set-down voltage Vsetdn and that of the low potential sustain voltage Vs_low are equal to each other.

21. The driving method of claim 19, wherein a middle voltage Vsm (hereinafter referred to as a “sustain central voltage”) between the high potential sustain voltage Vs_high and the low potential sustain voltage Vs_low is set to a ground level GND.

22. The driving method of claim 19, wherein the sustain central voltage Vsm is set to a positive voltage level.

23. The driving method of claim 19, wherein the sustain central voltage Vsm is set to a negative voltage level.

24. The driving method of claim 19, wherein a voltage difference V1 between the sustain central voltage Vsm and the first set-up voltage Vsetup1 and a voltage difference V2 between the first set-up voltage Vsetup1 and the second set-up voltage Vsetup2 are equal to each other.

25. The driving method of claim 19, wherein a voltage difference between the sustain central voltage Vsm and the set-down voltage Vsetdn is equal to the V1 and/or the V2.

26. The plasma display apparatus of claim 7, wherein a voltage difference between the positive voltage source and the negative voltage source is constant, and
the absolute values of the respective voltage sources are equal to each other.
